(19) United States
(12) Patent Application Publication
(10) Pub. No.: US 2025/0095520 A1
(43) Pub. Date: Mar. 20, 2025

(54) HOLOGRAPHIC DECODING AND DISPLAYING METHODS AND DEVICES FOR EXCHANGING CONFIGURATION DATA

(71) Applicant: InterDigital CE Patent Holdings, SAS, Paris (FR)

(72) Inventors: Didier Doyen, Cesson-Sevigne (FR); Valerie Allie, Saint-Armel (FR); Valter Drazic, Betton (FR); Arno Schubert, Val d'Izé (FR)

(21) Appl. No.: 18/294,237

(22) PCT Filed: Jul. 5, 2022
(86) PCT No.: PCT/EP2022/068642

§ 371 Date: Feb. 1, 2024

(30) Foreign Application Priority Data
Aug. 3, 2021 (EP) 21306081.7

(51) Int. Cl. G09G 3/00; G03H 1/08; G06F 3/14

(52) U.S. Cl. CPC G09G 3/001; G03H 1/0808; G06F 3/14; G03H 2226/02; G09G 2340/0435

(57) ABSTRACT

A holographic display device accepts different configurations for rendering a Computer Generated Hologram. The decoder which prepares the CGH may not have the required memory and processing resources to provide the holographic display device with CGH generated in the nominal preferred configuration. According to the present principles, messages are exchanged between the holographic decoder and the holographic display device to select a configuration that the holographic display device accept and that fit the memory and processing resources of the holographic decoder.

### 1. TECHNICAL FIELD

The present principles generally relate to the domain of decoding and displaying holographic images. The present document is also understood in the context of exchanging parameter data between a holographic image decoder and a holographic display. In particular, the present document relates to methods and protocols to exchange parameter data between a holographic decoder and a holographic display device to optimize the holographic image data format.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

The principle of Holography is to reconstruct the exact same light wave front emitted by a 3-dimensional object. This wave front carries all the information on parallax and distance. This information is lost by 2-dimensional conventional imaging systems (digital cameras, 2D images, 2D displays . . . ), and only parallax can be retrieved displaying recent volumetric contents on lightfield displays. The impossibility of such displays to render depth cues correctly leads to visual conflicts, which can cause eye strain, headache, nausea and lack of realism.

With the emergence of liquid crystal displays, the possibility of modulating the phase of an incoming wave front, and thus of shaping it at will, makes it possible to display a sampled object wavefront on dynamic devices. The hologram can be computed by a processor and referred to under the denomination Computer Generated Hologram (CGH). The synthesis of CGH requires the computation of the wavefront that was frozen by the interference with the reference beam in optical holography. The wavefront calculation can be done through various methods using Fourier optics.

There are several display technologies that have already been used as holographic displays. The processor that decodes and prepares the CGH representation shall provide the display device with images in a data format that is adapted to the technology of the display. If the decoder provides images in a format that is not adapted to the display device, the display device will adapt them up to its capabilities. A comparable issue occurs, for example, when a personal computer provides images to a television set that cannot handle the provided resolution. The television set adapts the image up to its displaying capabilities and the images are stretched or cut out.

The decoder generates the CGH before providing it to the holographic display device. Commonly, the decoder is not dedicated to this display. The decoder comprises a general purpose processor that can be a CPU, a GPU or any other kind of processor. Its capabilities are limited. However, CGH calculation is an intensive task. To feed the display device, the decoder must know the kind of holographic display it has to address. It must also know some of the characteristics of this display to precisely calculate the CGH. Then if the decoder has not enough capabilities, it should be able to adapt its processing to still be able to deliver a content that is, if not the optimum one for the display device, at least a content that the display device can use. There is a lack of a mechanism that allows a decoder and a display device to exchange information about their respective characteristics/capabilities to optimize the rendering by the holographic display device.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method implemented by a holographic decoder connected to a holographic display device. The method comprises:
sending a signal to the holographic display device indicating that the holographic decoder is active;
receiving a message from the holographic display device comprising at least a first configuration accepted by the holographic display device;
determining a second configuration according to the at least a first configuration; and
generating a Computer Generated Hologram in a data format determined according to the second configuration and sending the computer generated hologram to the holographic display device.

The present principles also relate to a holographic decoder connected to a holographic display device and implementing the method above.

The present principles also relate to a method implemented by a holographic display device connected to a holographic decoder. The method comprises:
receiving a signal indicating that the holographic decoder is active;
sending a message to the holographic decoder comprising at least a first configuration accepted by the holographic display device;
receiving, from the holographic decoder, a Computer Generated Hologram in a data format determined according to a second configuration selected according to the at least a first configuration and rendering the computer generated hologram.

The present principles also relate to a holographic display device connected to a holographic decoder and implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 shows how the illumination direction of the screen by the laser of a holographic display device can be represented;

FIG. 2 shows an example of an embodiment of the format of Computer Generated Hologram data;

FIG. 3 shows an example architecture of a device 30 which may be configured to implement a method or a device (decoder or display device) described in relation with FIGS. 4 to 6;

FIG. 4 illustrates a system 40 comprising a holographic decoder 41 and a holographic display device 42 according to a non-limiting first embodiment of the present principles;

FIG. 5 illustrates a system 50 comprising a holographic decoder 41 and a holographic display device 42 according to a non-limiting second embodiment of the present principles;

FIG. 6 illustrates a system 60 comprising a holographic decoder 41 and a holographic display device 42 according to a non-limiting third embodiment of the present principles.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

The principle of Holography is to reconstruct the exact same light wave front emitted by a 3-dimensional object. This wave front carries all the information on parallax and distance. Both types of information are lost by two-dimensional imaging systems (digital cameras, 2D images, 2D displays . . . ), and only parallax can be retrieved by displaying recent volumetric contents on light-field displays. The impossibility for such displays to correctly render depth cues leads to visual conflicts, which can cause eye strain, headache, nausea and lack of realism.

Holography is originally based on the recording of the interferences created by a reference beam, coming from a coherent light source, and an object beam, formed by the reflection of the reference beam on the subject. In the state of the art, the interference pattern is recorded in photosensitive material, and locally (microscopically) looks like a diffraction grating, with a grating pitch of the order of the wavelength used for the recording. Once recorded, illumination of the interference pattern by the original reference wave re-creates the object beam, and the original wave front of the 3D object.

This concept of holography evolved into the modern concept of Digital Holography. The requirements of high stability and photosensitive material made holography impractical for the display of dynamic 3D content. With the emergence of liquid crystal displays, the possibility of modulating the phase of an incoming wave front, and thus of shaping it at will, made it possible to display a sampled object wavefront on dynamic devices. The hologram can now be computed and referred to under the denomination Computer Generated Hologram (CGH). The synthesis of CGH requires the computation of the wavefront that was frozen by the interference with the reference beam in optical holography. The wavefront calculation can be done through various methods using Fourier optics. The object beam (i.e. the hologram) can be obtained by illuminating an LCOS SLM display, bearing the CGH, with the reference beam.

There are several ways to calculate a CGH depending on the source that is considered. When applied to a point cloud, each point is considered as a coherent light source. The CGH corresponds to the sum of the complex amplitude contribution of each point considered a light source. The calculation cost is huge since it is in the magnitude of the number of points of the point cloud times the resolution in pixels of the hologram plane.

To reduce this amount of calculation a layer-based approach is preferred. The principle is to calculate the hologram by applying a FFT-based processing to layers. A layer is a group of pixels at a given depth, they are all propagated to the hologram plan using a single FFT-based operation. The 3D content is then organized as a group of layers, with pixels belonging to the same layer being considered to have the same depth. In the next sections we describe the MPI format which is a layer-based format to define a 3D content and how a point cloud can be transformed to a layer content.

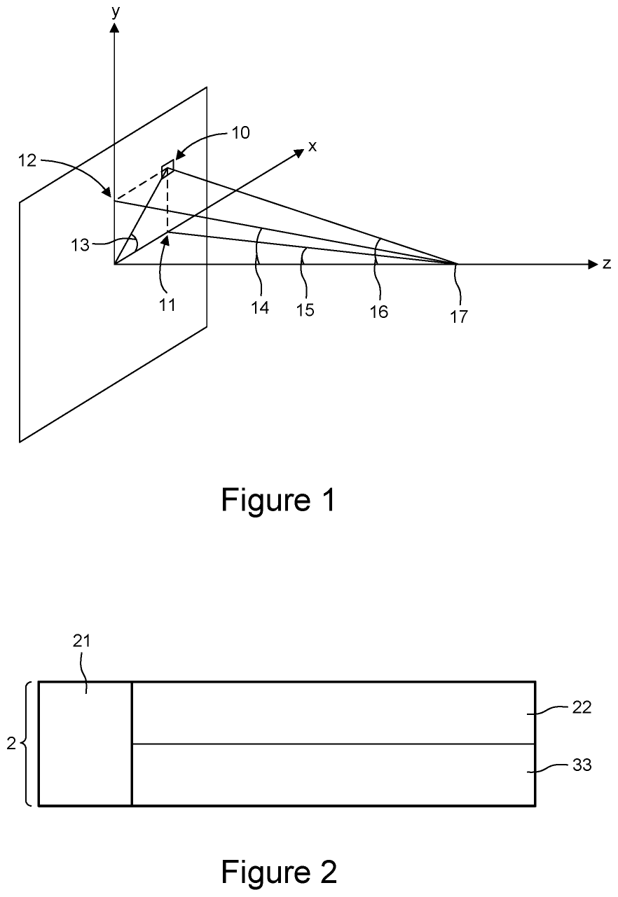

FIG. 1 shows how the illumination direction of the screen by the laser of a holographic display device can be represented. Indeed, the illumination direction is one of the key factors for the quality of the holographic rendering.

Several display technologies have already been used as holographic displays. For instance, in “Review on the State-of-the-Art Technologies for Acquisition and Display of Digital Holograms” by Peter Wai Ming Tsang and Ting-Chung Poon (herein referenced as [1]), an overview of different display technology categories that can render a CGH is provided in section 4. Depending on the technology, the decoder shall deliver to the display device a data format that is adapted to the technology to make the system working properly. There are two main categories of holographic displays depending on whether they can render both amplitude/phase or real/imaginary of the hologram or only the phase information. In both cases the display is called a SLM (Spatial Light Modulator).

To display both the amplitude and the phase, the system must have two different display devices in the system. It can be two separated SLMs or a single SLM split into two parts such as described in section 4 of [1]. The other category targets a single SLM to display only the phase information of the hologram. Different algorithms are available to convert a complex hologram into a phase-only-hologram (POH) such as described in section 5 of [1]. Gerchberg-Saxton Algorithm (GSA), One-Step-Phase-Retrieval (OSPR) or error diffusion are examples of algorithms to convert a complex hologram into a POH. But even with POH there are several flavors of it. The OSPR is a binary phase hologram that can be repeated several times with different input random noise to improve its level-to-noise ratio. GSA or error diffusion are providing a phase coded on n bits that is directly used by the SLM.

The wavelength of the lasers used by the holographic display and the pixel pitch of the SLM are also important parameters that impact the CGH/POH creation. The diffraction angle is directly linked to these parameters as shown by the equation eq1.

$$sin {θ}_{m} = \frac{m λ}{p} \qquad eq 1$$

Here, m is the diffraction order, m being a relative integer, λ is the wavelength, p the pixel pitch of the SLM and finally, θₘ is the diffraction angle of the order m. As the reconstructed image is present in each order |m|>0, this also means that the reconstructed image that extends in angular space (the Field of View (FoV)) also equals this value. The smaller the pixel pitch p, the broader is the FoV. Hence, the pixel pitch is an important parameter of the system. For the equation to be valid, it is supposed that the SLM, the reference beam and the reconstructed image occur in the same medium, usually air.

In consequence, the decoder that generates the hologram must be aware of the display technology and of the parameters of the display that will be used to provide the expected data format and the expected CGH/POH properties. The decoder also needs to be aware of the illumination hardware needed to generate the hologram, and in particular, the available wavelengths. Generally, the true-color hologram is generated with three lasers of blue, green and red wavelength, and the precise values have to be known too.

Moreover, usually, |m|=1. The direction of illumination, illustrated in FIG. 1, is also of interest depending on the display hardware. If the SLM is illuminated from a non-normal direction, then the in and out angles are linked by:

$$sin {θ}_{x}^{m} = \frac{{m}_{x} λ}{{p}_{x}} + sin {θ}_{x i} \qquad eq2a$$

$$sin {θ}_{y}^{m} = \frac{{m}_{y} λ}{{p}_{y}} + sin {θ}_{y i} \qquad eq2b$$

Where i is point 10, xi and yi are coordinates 11 and 12 of point 10, θₓᵢ and θ_{yi} are angles 15 and 14, the laser source being point 17. The SLM has rows and columns and can be characterized by a pair of pixel pitch sizes (pₓ, p_{y}), one along the rows and the other along the columns. mₓ and m_{y} are the horizontal and vertical diffraction orders.

The illumination direction is characterized by two angles (θᵢ,fᵢ) ((13,16) in FIG. 1) in spherical coordinates. There is a second way to describe the direction of illumination, which is a little bit more convenient for calculating the diffracted directions, it is the horizontal and vertical polar angles (θₓᵢ, θ_{yi}) ((15,14) in FIG. 1).

The reconstructed image is then diffracted into the various directions given by the diffraction equations eq2a and eq2b. In a prototype or in a proprietary solution, the decoder knows the display and the global system is built accordingly. In a more general case, the decoder may not know the display in advance. The decoder shall receive information to anticipate the way it has to deliver the data. The display technology, the resolution and the frame rate the display can handle, the wavelength of each laser used by the display and the pixel pitch of the display are parameters that shall be provided to the decoder. The diffraction order and the wavelength are additional parameters. The wavelength is an important part of the holographic display.

FIG. 2 shows an example of an embodiment of the format of Computer Generated Hologram data. The structure consists in a container which organizes the stream in independent elements of syntax. The structure may comprise a header part 21 which is a set of data common to every syntax elements of the stream. For example, the header part comprises some of metadata about syntax elements, describing the nature and the role of each of them. The header part may also comprise information about the hologram or the sequence of holograms. The structure comprises a payload comprising an element of syntax 22 and at least one element of syntax 23. Element of syntax 22 comprises data representative of the color and depth of pixels. The at least one element of syntax 23 is a part of the payload of the data stream and may comprise metadata about how the element of syntax 22 is encoded. Such metadata may be associated with each frame of the holographic video or to group of holograms.

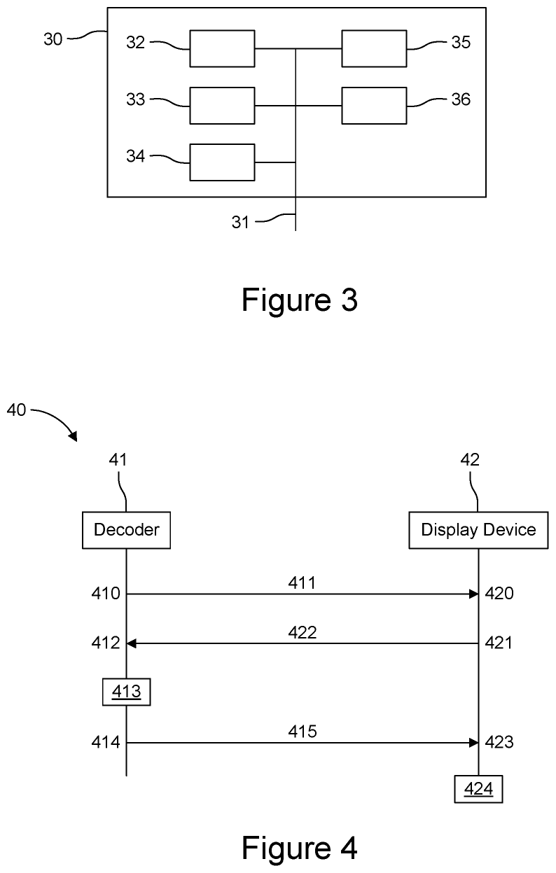

FIG. 3 shows an example architecture of a device 30 which may be configured to implement a method or a device (decoder or display device) described in relation with FIGS. 4 to 6. Alternatively, each circuit of a holographic decoder or a holographic display device may be a device according to the architecture of FIG. 3, linked together, for instance, via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 is configured to implement a method or a deice described in relation with FIGS. 4 to 6, and belongs to a set comprising:
a mobile device;
a communication device;
a game device;
a tablet (or tablet computer);
a laptop;
a decoding chip;
a server (e.g. a broadcast server, a video-on-demand server or a web server).

According to the present principles, data protocols between the holographic display and the processor that generates the CGH for the holographic display are proposed.

In a first embodiment, a set of registers that the display shall provide to the decoder to communicate specific data for a holographic display is proposed and comprises:
The wavelength of the lasers used in the display. These values can be given in nanometers (nm) for all the lasers used in the display (e.g. three values for R, G and B).
The pixel pitch of the SLM. This value is given in nm and will be on 24 bits to allow a good precision and a wide range of value.
The display technology used to render the hologram (e.g. SLM with POH value on 8 bits, SLM split into two parts or SLM displaying the POH on a binary format at high speed).
The resolution of the display (e.g. 1920*1080 pixels).
The frame rate of the display (e.g. 30 Hz, 50 Hz or 60 Hz).
The diffraction order the display preferentially uses. (5 possible values 0, −1, 1, −2, 2).
The direction of the illumination lasers available. (Polar angle, as illustrated in FIG. 1, with respect to SLM's normal given in 16 bits).

In second and third embodiments, exchange protocols between the display and the decoder to get at the end the best trade-off in term of hologram sent to the display are proposed. The trade-off is determined based on a preferred format for the display based on limited capabilities of the decoder. If the decoder cannot deliver the hologram at the full resolution and at the full frame rate, according to the present principles, several possibilities to generate a limited version depending on the display technology are proposed.

FIG. 4 illustrates a system 40 comprising a holographic decoder 41 and a holographic display device 42 according to a non-limiting first embodiment of the present principles. Vertical lines illustrate a method for each of the devices. Horizontal lines illustrate data exchanged between the two devices.

On decoder 41 side, at a starting step 410, the decoder signals itself to display device 42. Message 411 is sent from decoder 41 to display device 42 to signal that the decoder is active, available for providing a CGH. Message 411 may take the form of a HDMI connection signal. Message 411 may comprise information like an identification number of the decoder. At a step 412, the decoder receives a message 422 from display device 42. Message 422 can comprise the following parameters describing a holographic display device:
Display technology (8 bits): one bit per technology
The wavelength of RGB laser (16 bits): 2 bytes per wavelength in nm
The pixel pitch of the SLM (24 bits): pixel pitch in nm from 1.0 nm to 16.777 mm
Accepted data format by the display (8 bits): one bit per data format
Bit per pixel (8 bits): one bit per value
Nominal picture size (32 bits): 2 bytes per dimension H&V in pixels, the nominal picture is the preferred value (see embodiment 3)
Nominal frame rate (16 bits): 2 bytes for the frame rate in Hz
Number of accepted picture size (8 bits) (see embodiment 3): Np
Accepted picture size (Np*32 bits):
   Np*picture size (32 bits): 2 bytes for each set of dimension H&V in pixels
Number of accepted frame rate (8 bits) (see embodiment 3): Nf
Accepted frame rate (Nf*16 bits):
   Nf*frame rate (16 bits): 2 bytes for each frame rate in Hz

DisplayID v2.0 describes the second-generation version of VESA DisplayID Standard. Use of DisplayID v2.0 structures is intended to replace use of Extended Display Identification Data (EDID) structures to describe capabilities of new display devices. Message 422 may be defined as an extension of DisplayID. In this case, message 422 is an extra block dedicated to the holographic display. It can be inserted, for instance, at the address 0xx2A. A possible description of this block is provided in the following table:

| Byte offset | Bit/value | Description/Format |
|---|---|---|
| 00h | 0x2A | Holographic display Interface block tag |
| 01h | Bits 2:0 | Revision: 0 |
| 02h | Bits 7:0 | Number of payload bytes |
| 03h | Bits 7:0 | Display technology |
| | | Bit0: LCOS |
| | | Bit1: FLCOS |
| | | Bit2: DLP |
| | | Bit3: . . . |
| 04h | Bits7:0 | Wavelength green LSB in nm |
| 05h | Bits7:0 | Wavelength green MSB in nm |
| 06h | Bits7:0 | Wavelength red LSB in nm |
| 07h | Bits7:0 | Wavelength red MSB in nm |
| 08h | Bits7:0 | Wavelength blue LSB in nm |
| 09h | Bits7:0 | Wavelength blue MSB in nm |
| 0Ah | Bits7:0 | Pixel pitch (7 . . . 0) in nm |
| 0Bh | Bits7:0 | Pixel pitch (15 . . . 8) in nm |
| 0Ch | Bits7:0 | Pixel pitch (23 . . . 16) in nm |
| 0Dh | Bits7:0 | Accepted data format by the display |
| | | Bit0: Phase only |
| | | Bit1: Phase and amplitude |
| 0Eh | Bits7:0 | Bit per pixel |
| | | Bit0: 1 bit |
| | | Bit1: 8 bits |
| | | Bit2: 16 bits |
| | | Bit3: 32 bits |
| 0Fh | Bit 7:0 | Nominal Display resolution in Horizontal |
| | | (LSB) |
| 10h | Bit 7:0 | Nominal Display resolution in Horizontal |
| | | (MSB) |
| 11h | Bit 7:0 | Nominal Display resolution in Vertical (LSB) |
| 12h | Bit 7:0 | Nominal Display resolution in Vertical (MSB) |
| 13h | Bit 7:0 | Nominal frame rate (LSB) |
| 14h | Bit 7:0 | Nominal frame rate (MSB) |
| 15h | Bit 7:0 | Number of accepted picture size = Np |
| 16h | Bit 7:0 | First Display resolution in Horizontal (LSB) |
| 17h | Bit 7:0 | First Display resolution in Horizontal (MSB) |
| 18h | Bit 7:0 | First Display resolution in Vertical (LSB) |
| 19h | Bit 7:0 | First Display resolution in Vertical (MSB) |
| 1Ah | Bit 7:0 | Second Display resolution in Horizontal (LSB) |
| . . . | Bit 7:0 | . . . |
| 19h + Np*4 | Bit 7:0 | Last Display resolution in Vertical (MSB) |
| 1Ah + Np*4 | Bit 7:0 | Range of accepted frame rate: lower value |
| | | (MSB) |
| 1Bh + Np*4 | Bit 7:0 | Range of accepted frame rate: lower value |
| | | (LSB) |
| 1Ch + Np*4 | Bit 7:0 | Range of accepted frame rate: higher value |
| | | (MSB) |
| 1Dh + Np*4 | Bit 7:0 | Range of accepted frame rate: higher value |
| | | (LSB) |
| 1Eh + Np*4 | Bit 7:0 | Diffraction order used m |
| | | Bit0: m = 0 |
| | | Bit1: m = −1 |
| | | Bit2: m = 1 |
| | | Bit3: m = −2 |
| | | Bit4: m = 2 |
| 1Fh + Np*4 | Bit 7:0 | direction of the illumination green laser (MSB) |
| 20h + Np*4 | Bit 7:0 | direction of the illumination green laser (LSB) |
| 21h + Np*4 | Bit 7:0 | direction of the illumination red laser (MSB) |
| 22h + Np*4 | Bit 7:0 | direction of the illumination red laser (LSB) |
| 23h + Np*4 | Bit 7:0 | direction of the illumination blue laser (MSB) |
| 24h + Np*4 | Bit 7:0 | direction of the illumination blue laser (LSB) |

At a step 413, the decoder selects parameters for generating a CGH (or a sequence of CGHs) according to the information received in message 422 and its own capabilities. The decoder implements an algorithm that is able to test the possible configurations proposed in message 422 in regard to its own capabilities (i.e. memory and processing resources). Such an algorithm computes a score for each possible configuration and the one with the best score is selected.

At a step 414, decoder 41 generates a CGH 415 (or a sequence of CGHs 415) according to the selected parameters and provide CGH 415 to holographic display device 42.

On holographic display device 42 side, at a step 420, the display device receives a connection message 411 from decoder 41. This message signals that the decoder is active and available for providing CGH. In reaction, at a step 421, the display device sends a message 422 describing itself to the decoder as described above. At a step 423, the display device receives data representative of a CGH 415 prepared in a data format selected to fit capabilities and preferences of the display device. At a step 424, display device 42 renders and displays received CGH 415.

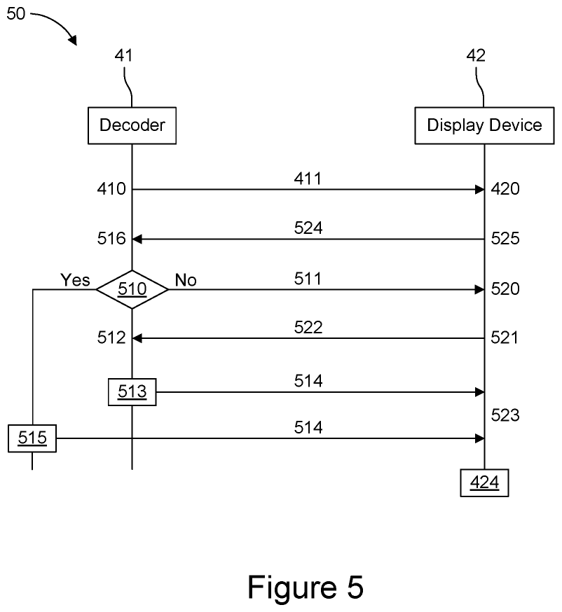

FIG. 5 illustrates a system 50 comprising a holographic decoder 41 and a holographic display device 42 according to a non-limiting second embodiment of the present principles. Vertical lines illustrate a method for each of the devices. Horizontal lines illustrate data exchanged between the two devices. In the second embodiment, the display takes the decision to define the best trade-off.

On decoder 41 side, at a starting step 410, the decoder signals itself to display device 42. Message 411 is sent from decoder 41 to display device 42 to signal that the decoder is active, available for providing a CGH. Message 411 may take the form of a HDMI connection signal. Message 411 may comprise different information like an identification number of the decoder. At a step 516, the decoder receives a message 524 from display device 42. Message 524 comprises the frame rate and the resolution of the display device. At a step 510, the decoder estimates whether it is powered enough to generate the CGH (or the sequence of CGH) at the frame rate and the resolution provided by the display device in message 524. The decoder tests the generating of a CGH at the provided resolution and computes the required time. Thus, the decoder can estimate at what percentage of the provided frame rate it can generate CGHs at this resolution. The CGH cost calculation principle is the following: the CGH is calculated from a given content with a given resolution (Rc) and a given frame rate (FRc). The CGH is calculated at a given frame rate (FRh) and at a given resolution (Rh). Different algorithms of the state of the art exist to calculate a CGH and two categories can be considered, one based on a per pixel calculation (Rayleigh Sommerfield RS), the other one based on Fourrier Transforms FFT. In the per pixel approach, the computation cost is directly proportional to the product Rc*Rh*FRh. In the second approach (FFT based), the result is proportional to the logarithm of the resolution time the frame rate. In both cases, the computation cost is proportional to the frame rate, and it increases with the resolution (linear or logarithmic). So, a lowering of the frame rate and/or the resolution would reduce the calculation time. So, the decoder can calculate the computation cost of the CGH for a given nominal frame rate/resolution and a given algorithm. This value is compared to the maximum capacity of the processor. The response can be 100% if the processor can generate the CGH at the nominal properties. Or the processor cannot perform the CGHs generating under these conditions, but it can handle it at a percentage of it. The response is a performance value that can take another form than a percentage.

On condition that the decoder can generate CGHs at the resolution and the frame rate proposed in message 524, a step 515 is performed, and the decoder generates and sends CGH 514 (or sequence of CGH 514) at the frame rate and at the resolution proposed in message 524 to display device 42.

If not, the decoder sends a message 511 to the display device. Message 511 comprises an indication of a percentage of the capacities of the decoder relative to the requirements of message 524. This percentage is greater than 100% because the decoder is not able to provide a CGH at this frame rate and/or resolution. For example, if generating a CGH under these conditions requires 125% of the capabilities of the decoder, message 511 comprises an information indicating 125%. In a variant, message 524 comprises the percentage of the capabilities of the decoder for generating such a CGH. In the same example, message 524 would comprises an information indicating 80%. At a step 512, the decoder receives a response 522 from the decoder. Response 522 comprises a new frame rate and a new resolution. It can be the parameters that display device 42 can handle and that may fit the capabilities of the decoder, or it can be the lowest parameters display device 42 can handle if the decoder does not have the required capabilities. At a step 513, the decoder generates the CGH 514 (or the sequence of CGH 514) at the frame rate and at the resolution indicated in message 522 and sends the CGH 514 to display device 42.

On holographic display device 42 side, a step 420, the display device receives a connection message 411 from decoder 41. This message signals that the decoder is active and available for providing CGH. In reaction, at a step 525, the display device sends a message 524 describing itself to the decoder. Message 524 comprises a selected (preferred) resolution and a selected (preferred) frame rate.

At step 520, the display device may receive a message 511 from the decoder indicating that the decoder is not able to provide CGHs at this resolution and at this frame rate. Message 511 comprises a performance value, for example a percentage, representative of the capabilities of the decoder to provide CGHs at the resolution and frame rate indicated in message 524. In this case, at a step 511, holographic display device 42 selects parameters (resolution+frame rate) within the list of parameters the display device can handle, the selected parameters being lower (the resolution and/or the frame rate) than the parameters provided in message 524 according to the performance value. Holographic display device 42 implements an algorithm that can estimate a performance value for a given configuration as a function of a performance value provided for the reference configuration provided in message 524. The selected resolution and frame rate are sent to the decoder in a message 522.

At a step 523, data representative of a CGH 514 prepared in data format selected to fit capabilities and preferences of the display device provided in message 524 or in message 522. At a step 424, display device 42 renders and displays received CGH 415.

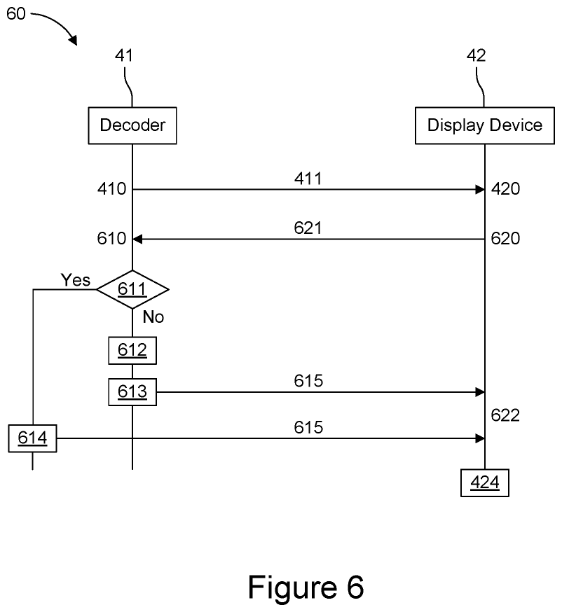

FIG. 6 illustrates a system 60 comprising a holographic decoder 41 and a holographic display device 42 according to a non-limiting third embodiment of the present principles. Vertical lines illustrate a method for each of the devices. Horizontal lines illustrate data exchanged between the two devices. In the third embodiment, decoder 41 takes the decision to define the best trade-off.

On decoder 41 side, at a starting step 410, the decoder signals itself to display device 42. Message 411 is sent from decoder 41 to display device 42 to signal that the decoder is active, available for providing a CGH. Message 411 may take the form of a HDMI connection signal. Message 411 may comprise different information like an identification number of the decoder. At a step 610, the decoder receives a message 621 from holographic display device 42. Message 621 comprises a list of information items comprising of a picture resolution (i.e. the picture size in pixels) and a frame rate that holographic display 42 can accept. The list can comprise every configuration the display device can deal with to render and display a CGH or a sequence of CGHs. In variants, an information item comprises additional parameters of a configuration. For example, an information item of the list comprised in message 621 may comprise a resolution of the picture or a number of accepted colors. Indeed, a low-capacity decoder may be able to generate CGHs with only one color. An information item may comprise any of the parameters listed in relation to FIG. 4, like a number of layers. One of the information items of the list of message 621 is the nominal configuration of the display device, that is a configuration that allows the best rendering quality. The nominal configuration is, for example, the first information item of the list of message 621.

At a step 611, the decoder estimates whether it is powered enough to generate the CGH (or the sequence of CGH) in the nominal configuration described in message 621. The decoder tests the generating of a CGH according to the principles described in relation to FIG. 5.

If the decoder estimates it is powered enough for the nominal configuration, a step 614 is performed. At step 614, a CGH 615 (or a sequence of CGHs 615) is generated in the nominal configuration and sent to holographic display device 42.

If the decoder estimates it is not powered enough for the nominal configuration, a step 612 is performed. At step 612, The decoder estimates a computation cost for generating a CGH (or a sequence of CGHs) in each of configurations described by information items of the list of message 621. The decoder selects one of the possible configurations. The decoder determines the best trade-off between its capabilities and a rendering quality associated with the configuration. At a step 613, a CGH 615 (or a sequence of CGHs 615) is generated in the selected configuration and sent to holographic display device 42.

On holographic display device 42 side, a step 420, the display device receives a connection message 411 from decoder 41. This message signals that the decoder is active and available for providing CGH. In reaction, at a step 620, the display device sends a message 621 describing itself to the decoder as described above. Message 621 comprises a list of information items describing every configuration the display device can accept. One of the information items of the list is the nominal configuration, that is, the configuration that can be used for the best rendering quality. At a step 622, the display device receives data representative of a CGH 615 prepared in a data format selected to fit capabilities and preferences of the display device. At a step 424, display device 42 renders and displays received CGH 615.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A holographic decoder configured for connection to a holographic display device, the holographic decoder comprising a memory associated with a processor configured to:
receive a message from the holographic display device, the message comprising at least a first configuration accepted by the holographic display device; wherein a first configuration comprises a picture resolution, a frame rate, memory and processing resources of the holographic decoder and wherein the message comprises a nominal configuration;
select a second configuration accepted by the holographic decoder according to the at least a first configuration by:
determining a computation cost of a generating of a computer generated hologram in the nominal configuration;
on condition that the memory and processing resources of the holographic decoder enable the computation cost, setting a second configuration to the nominal configuration;
on condition that the memory and processing resources of the holographic decoder do not enable the computation cost, estimating a computation cost of a generating of a computer generated hologram in each of the at least a first configuration and setting the second configuration to one of the at least a first configuration; and
generate a computer generated hologram in a data format determined according to the second configuration and send the computer generated hologram to the holographic display device.

2. The holographic decoder of claim 1, wherein the at least a first configuration comprises:
a display technology,
a wavelength of red, green, blue (RGB) laser,
a pixel pitch of a spatial light modulator,
accepted data formats,
a bit per pixel value,
a nominal picture size,
a nominal frame rate,
a number of accepted picture sizes,
a list of accepted picture sizes,
a number of accepted frame rates, and
a list of accepted frame rates;
and wherein, the processor is configured to select the second configuration according to the at least a first configuration by testing if memory and processing resources of the holographic decoder enable the second configuration.

3. The holographic decoder of claim 1, wherein the processor is configured to select the second configuration by:
determining a computation cost of a generating of a computer generated hologram under the at least a first configuration;
on condition that the memory and processing resources of the holographic decoder enable the computation cost, setting the second configuration to the at least a first configuration;
on condition that the memory and processing resources of the holographic decoder do not enable the computation cost,
sending a message to the holographic display device comprising a value representative of a capacity of the holographic decoder to provide the holographic display device with a computer generated hologram according to the at least a first configuration; and
receiving a new configuration comprising a frame rate and a picture resolution accepted by the holographic display device and setting the second configuration to the new configuration.

4. (canceled)

5. A holographic display device connected to a holographic decoder, the holographic display device comprising a memory associated with a processor configured to send a message to the holographic decoder comprising at least a first configuration accepted by the holographic display device, a first configuration comprising a picture resolution and a frame rate; the message comprising a nominal configuration;
receive, from the holographic decoder, a computer generated hologram in a data format determined according to a second configuration selected according to the at least a first configuration by the holographic decoder and render the computer generated hologram.

6. The holographic display device of claim 5, wherein the at least a first configuration comprises:
a display technology,
a wavelength of red, green, blue (RGB) laser,
a pixel pitch of a spatial light modulator,
accepted data formats,
a bit per pixel value,
a nominal picture size,
a nominal frame rate,
a number of accepted picture sizes,
a list of accepted picture sizes,
a number of accepted frame rates, and
a list of accepted frame rates.

7. The holographic display device of claim 5, wherein the processor is configured to receive a message from the holographic decoder comprising a value representative of a capacity of the holographic decoder to provide the holographic display device with a computer generated hologram according to the at least a first configuration; and send a new configuration comprising a frame rate and a picture resolution accepted by the holographic display device according to the value.

8. (canceled)

9. A method implemented by a holographic decoder connected to a holographic display device, the method comprising:
sending a signal to the holographic display device indicating that the holographic decoder is active;
receiving a message from the holographic display device comprising at least a first configuration accepted by the holographic display device, a first configuration comprising a picture resolution and a frame rate, the message comprising a nominal configuration;
determining a second configuration accepted by the holographic decoder according to the at least a first configuration by:
determining a computation cost of a generating of a computer generated hologram in the nominal configuration;
on condition that memory and processing resources of the holographic decoder enable the computation cost, setting the second configuration to the nominal configuration;
on condition that memory and processing resources of the holographic decoder do not enable the computation cost, estimating a computation cost of a generating of a computer generated hologram in each of information items of the list and setting the second configuration to one of the information items according to the computation cost and memory and processing resources of the holographic decoder; and
generating a computer generated hologram in a data format determined according to the second configuration and sending the computer generated hologram to the holographic display device.

10. The method of claim 9, wherein the at least a first configuration comprises:
a display technology,
a wavelength of red, green, blue (RGB) laser,
a pixel pitch of a spatial light modulator,
accepted data formats,
a bit per pixel value,
a nominal picture size,
a nominal frame rate,
a number of accepted picture sizes,
a list of accepted picture sizes,
a number of accepted frame rates, and
a list of accepted frame rates; and
the method comprising selecting the second configuration by testing the at least a first configuration according to memory and processing resources of the holographic decoder.

11. The method of claim 9, wherein the method comprises:
determining a computation cost of a generating of a computer generated hologram CGH under the at least a first configuration;
on condition that memory and processing resources of the holographic decoder enable the computation cost, setting the second configuration to the at least a first configuration;
on condition that memory and processing resources of the holographic decoder do not enable the computation cost,
sending a message to the holographic display device comprising a value representative of a capacity of the holographic decoder to provide the holographic display device with a computer generated hologram according to the at least a first configuration; and
receiving a new configuration comprising a frame rate and a picture resolution accepted by the holographic display device and setting the second configuration to the new configuration.

12. (canceled)

13. A method implemented by a holographic display device connected to a holographic decoder, the method comprising:
receiving a signal indicating that the holographic decoder is active;
sending a message to the holographic decoder comprising at least a first configuration accepted by the holographic display device, a first configuration comprising a picture resolution and a frame rate; the message comprising a nominal configuration; and
receiving, from the holographic decoder, a computer generated hologram in a data format determined according to a second configuration selected according to the at least a first configuration by the holographic decoder and rendering the computer generated hologram.

14. The method of claim 13, wherein the at least a first configuration comprises:
a display technology,
a wavelength of red, green, blue (RGB) laser,
a pixel pitch of a spatial light modulator,
accepted data formats,
a bit per pixel value,
a nominal picture size,
a nominal frame rate,
a number of accepted picture sizes,
a list of accepted picture sizes,
a number of accepted frame rates, and
a list of accepted frame rates.

15. The method of claim 13, wherein the method comprises receiving a message from the holographic decoder comprising a value representative of a capacity of the holographic decoder to provide the holographic display device with a computer generated hologram according to the at least a first configuration; and sending a new configuration comprising a frame rate and a picture resolution accepted by the holographic display device according to the value.

16. (canceled)
